(19) United States
(12) Patent Application Publication
(10) Pub. No.: US 2016/0135934 A1
(43) Pub. Date: May 19, 2016

(54) MOUTH CLEANER

(71) Applicants: Dany Unger, Daliat El-Carmel (IL); Jakob Dichtenberg, Kiryat Bialik (IL)

(72) Inventors: Dany Unger, Daliat El-Carmel (IL); Jakob Dichtenberg, Kiryat Bialik (IL)

(21) Appl. No.: 15/002,252

(22) Filed: Jan. 20, 2016

Related U.S. Application Data
(63) Continuation of application No. PCT/IL2013/050626, filed on Jul. 22, 2013.

(30) Foreign Application Priority Data
Jul. 25, 2012 (IL) 221116

(51) Int. Cl. A61C 17/00; A46B 15/00; A46B 11/00

(52) U.S. Cl. CPC A61C 17/00; A46B 11/0003; A46B 15/00

(57) ABSTRACT

A single use flexible disposable oral device, which is operated either by the tongue or by a chewing action, for cleaning the entire mouth cavity. The oral device contains a dentifrice and is made of a spongy material. It is formed as a cube having faces and is provided with voids at its external envelope. The edges and vertexes of the external envelope may be harder than the faces and an internal core of the cube. The oral device is contained within a package that may be flat and may contain flushing liquid.

### FIELD OF THE INVENTION

The present invention relates to the field of mouth and dental hygiene, and more particularly to the field of disposable devices that may be put in the mouth for cleaning the teeth and entire mouth cavity.

### BACKGROUND OF THE INVENTION

Devices for handling mouth and dental hygiene are known. Typically, a toothbrush is used in conjunction with some kind of a dentifrice. The toothbrushes vary in size, shape and function. Some of the toothbrushes are designed such that the bristles are formed with a concave shape in order to increase the contact surface with the teeth being brushed.

Since it is also important to reach the space between the teeth, whether between the incisors, the canines, or the premolars, some toothbrushes provide a group of bristles that are somewhat longer in order to enable better accessibility to the hard-to-reach spaces between the teeth. In other cases, a dental floss is uses in order to remove food residuals from the spaces between the teeth.

These days it is widely accepted that most of the bacteria that are affecting the health of the teeth and cause bad smell of the oral cavity are accumulating not only on the teeth and therebetween but also on the tongue. For that reason, many toothbrush manufacturers provide the toothbrush head with projecting ribs, located opposite the bristles, which help to rub and clean the tongue.

In order to brush the teeth, one has to get a toothbrush, open a toothpaste tube, apply a certain amount of toothpaste on the bristles of the toothbrush, close the toothpaste tube, and then brush the teeth for several minutes, including the internal and external sides of the superior dental arch and of the inferior dental arch. Upon completing the rubbing, including the tongue as previously mentioned, the toothpaste, being in a foam form by now, is spitted away from the mouth and then the mouth has to be thoroughly washed by means of water that are separately taken by the user.

Since this task is sometimes difficult to accomplish and since sometimes water is not available at the end of the tooth brushing, several appliances were developed in order to ease the task of tooth brushing.

Such an appliance is shown in US2008/0280251 A1 to Gallagher. The appliance disclosed in '251 is an oral appliance designed similarly to a mouth guard, in that it has two inverted channels in which the teeth are positioned when it is placed into the mouth. In its completed design it provides the user with the ability to brush all three exposed surfaces of the teeth of the upper and lower bite, the gingival margin, and the surface of the tongue.

The appliance of '251 suffers from several disadvantages: (a) it may not fit properly into some different mouth and teeth shapes. (b) it may not fit to every mouth and teeth size. (c) in some cases, the shape and size of the dental arches may cause a considerable friction between the teeth and the appliance, a fact that may cause discomfort when using the appliance, or even cancellation of use in extreme cases when the dental arches are locked within the appliance. (d) the appliance is too large therefore causing an unease feeling during use. (e) the appliance is too complex and therefore too expensive for a single use purpose. (f) the appliance is too large to be comfortably carried within a pocket of a shirt or of pants.

It is the object of the present invention to provide a dental device that significantly reduces or overcomes the aforementioned disadvantages.

It is a further object of the present invention to provide a dental device that will fit to different mouth and teeth shapes.

It is still a further object of the present invention to provide a dental device that will fit to different mouth and teeth sizes.

It is still yet a further object of the present invention to provide a dental device that has small volume and can be easily carried.

It is also a further object of the present invention to provide a dental device that is disposable and cheap.

It is another object of the present invention to provide a disposable dental kit that may be used to clean the teeth and to freshen up the breath without necessity of a toothbrush or availability of water source.

It is still yet another object of the present invention to provide a disposable dental kit that is efficient, easy to use, cheap, disposable, water soluble and bio-degradable.

It is still further another object of the present invention to provide a dental device that may first clean the mouth cavity and then can be eaten.

### SUMMARY OF THE INVENTION

In accordance with the present invention there is provided a single use flexible disposable oral device, which is operated either by the tongue or by a chewing action, for cleaning the entire mouth cavity.

If desired, the oral device includes an external envelope and an internal core,

the external envelope includes faces having edges and vertexes, and
the oral device being non-homogenous, and the vertexes are harder than the faces and the internal core.

Further if desired, the edges are harder than the faces and the internal core.

Advantageously, the oral device contains a dentifrice.

Typically, the oral device is made of a spongy material.

If desired, the oral device is made of algae.

Further if desired, the oral device is water soluble.

Still further if desired, the oral device is bio degradable.

In some embodiments, the oral device is in a form of a cube.

Advantageously, an external envelope of the oral device is provided with voids.

Typically, the oral device is contained within a package.

According to some embodiments, the package is flat.

If desired, the oral device is contained within an all-inclusive package.

In some embodiments, the all-inclusive package is provided with at least two package portions;
a first package portion contains therein the oral device, and
a second package portion contains therein flushing liquid.

If desired, the all-inclusive package includes at least two rigid compartments;
at least a first compartment includes therein the oral device, and
at least a second compartment includes therein flushing liquid.

Generally, the oral device forms a convex body.

Typically, in an un-squeezed form of the oral device, a maximal external dimension of the oral device is in the range of 5 mm to 50 mm.

In some cases, in an un-squeezed form of the oral device, a maximal external dimension of the oral device is in the range of 10 mm to 30 mm.

### BRIEF DESCRIPTION OF THE DRAWINGS

For a better understanding of the present invention and to show how the same may be carried out in practice, reference will now be made to the accompanying drawings, in which:

FIG. 1 is a perspective view of a first embodiment of an oral device according to the present invention;

FIG. 2 is a perspective view of a package of the oral device of FIG. 1 wrapped in a bulky form;

FIG. 3 is a plan view of the package of FIG. 2;

FIG. 4 is a side view of the package of FIG. 2;

FIG. 5 is a perspective view of a package of the oral device of FIG. 1 wrapped in a flat form;

FIG. 6 is a plan view of the package of FIG. 5;

FIG. 7 is a side view of the package of FIG. 5;

FIG. 8 is a perspective view of an all-inclusive package according to the present invention;

FIG. 9 is a plan view of the all-inclusive package of FIG. 8;

FIG. 10 is a side view of the all-inclusive package of FIG. 8; and

FIG. 11 is a perspective view of a rigid all-inclusive package according to the present invention.

### DETAILED DESCRIPTION OF THE INVENTION

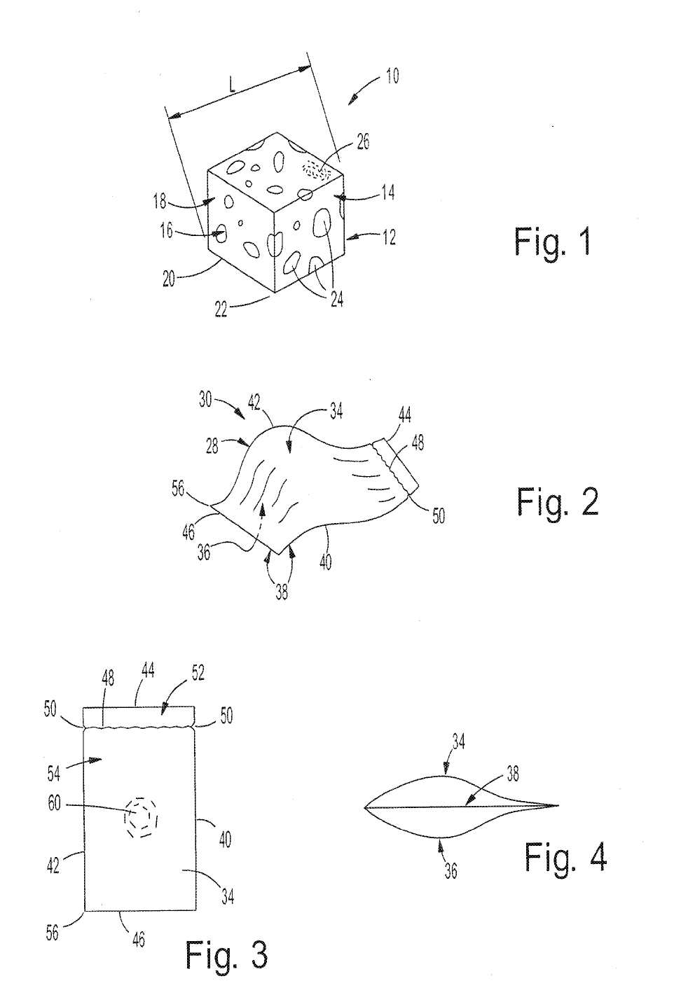

Attention is first drawn to FIG. 1 that shows an oral device 10 according to the present invention. As shown, the oral device 10 includes a sponge or a gauze in a form of a cube 12. In some embodiments, the cube 12 is homogenous in structure (however, in some embodiments as explained below, the cube is non-homogenous) and comprises an external envelope 14 and an internal core 16. The envelope 14 includes six faces 18 that are perpendicular to each other. Each two faces 18 meet at an edge 20. Each end of an edge 20 forms a vertex 22 of the cube 12.

In the shown embodiment, the oral device 10 forms a perfect convex body. In other embodiments (not shown), when the external surface of the oral device is formed with protruding bulges or deep grooves or slots, it is still remains a generally convex body. In still other embodiments (not shown), when the external surface of the oral device is formed with relatively large protruding arms, in order to enable better penetration into hard-to-reach spaces, then, in those cases, the external surface is not considered as a convex body.

Typically, a maximal external dimension L of the cube 12 in an un-squeezed position is between 5 mm to 50 mm. In most common embodiments, the maximal external dimension L is between 10 mm to 30 mm.

The cube 12 is airy by means of voids 24 formed within the internal core 16 of the cube 12. Some of the voids 24 open into the external envelope 14. In most of the embodiments, the cube 12 is fluffy, however, it may also be compressed to a desired degree.

The cube 12 is impregnated with a given quantity of a dentifrice 26 (shown as dots in FIG. 1). The dentifrice 26 may be evenly spread all along the cube 12, or, it may be applied only to given portions of the cube 12. The dentifrice 26 is typically in the form of toothpaste or mouthwash. The dentifrice 26 may have various properties as known in the art, for example, anti-bacterial, anti-inflammatory, antiseptic, cleanser, whitener, shiner, deodorizer and the like.

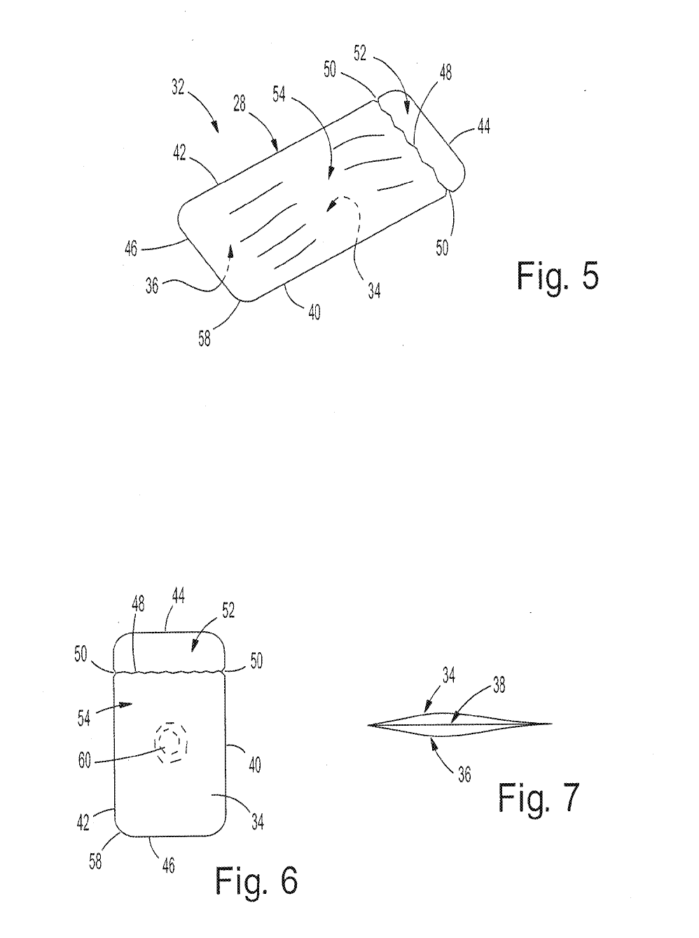

According to a first embodiment of the present invention, the oral device 10 is packed within a sealed package 28. In some cases, the package 28 is wrapped around the oral device 10 such that the cube 12 remains substantially unsqueezed. In that case, the package 28 may have a “bulky” look and be a bulky package 30, as seen in FIGS. 2 to 4. In other cases, the package 28 is wrapped around the oral device 10 such that the package 28 remains substantially flat, as seen in FIGS. 5 to 7. In which case, the cube 12 within the package 28 becomes somewhat flattened or even completely flat and the package 28 being a flat package 32.

As seen in FIGS. 2 to 7, the package 28 includes an upper surface 34, a lower surface 36, and sealing line 38 therebetween. The sealing line 38 is formed from a right sealing line 40 and a left sealing line 42 bounded between a front sealing line 44 and a rear sealing line 46.

As best seen in FIGS. 2, 3, 5 and 6, the package 28 includes, adjacent the front sealing line 44, a tearing line 48, extending between the right sealing line 40 and the left sealing line 42. The tearing line 48 is provided, at one or two ends thereof, with a notch 50 for easing the beginning of the tearing action when required. The package 28 includes two package portions, namely, a front package portion 52, forward to the tearing line 48, and a rear package portion 54, rearward to the tearing line 48.

It should be noted that directional terms appearing throughout the specification and claims, e.g. “forward”, “rear”, “upper”, “lower” etc., are used as terms of convenience to distinguish the location of various surfaces relative to each other. These terms are defined with reference to the figures, however, they are used for illustrative purposes only, and are not intended to limit the scope of the appended claims.

The intersection between the right sealing line 40 and left sealing line 42 to the front sealing line 44 and the rear sealing line 46 may be through sharp edges 56, as shown in FIGS. 2 and 3, or through rounded edges 58 as shown in FIGS. 5 and 6.

Typically, at least one side surface, being the upper surface 34 or the lower surface 36, is form with an inscription 60. The inscription 60 may contain various data, e.g., the name of the product, instructions for use of the product, relevant information about the product, and picture or drawing of the product. Furthermore, at some cases, a whole side surface, being the upper surface 34 or the lower surface 36, or a portion thereof, is used as a general advertising area.

The oral device 10 may be sold as an individual unit, as a package of several separate units within a box, bag or the like, or, as a continuous ribbon when the rear sealing line 46 of a given oral device 10 serves as the front sealing line 44 of the consecutive oral device 10.

In order to use the oral device 10 by a person, a single package 28 is held in hand. Then, one hand of the person holds the front package portion 52 and the other hand of the person holds the rear package portion 54. Then, by applying force in contrary directions, starting adjacent one of the notches 50, the tearing line 48 is torn apart and the cube 12 may be taken out of the package 28.

Now, the cube 12 is put in the mouth and starts to be moved by the person's tongue. The cube 12 is moved gently along all parts of the mouth cavity; above and under the tongue, between the teeth; the incisors, the canines and the premolars, between the internal and external sides of the superior dental arch and of the inferior dental arch, and along the internal and external gums.

Since the cube 12 is soft and fluffy, it can be easily squeezed to fit into the hard-to-reach spaces. When the cube 12 is squeezed, it enables more dentifrice to reach the external envelope 14 of the cube 12, thus improving the cleaning process. During the movement of the cube 12 within the mouth cavity, whether in a squeezed or an unsqueezed form, each vertex 22 of the cube 12 may easily enter between the teeth and help with the cleaning process.

During its movement, the cube 12 further collects all kinds of food residuals left in the mouth. These residuals, being crumbs, fruit and vegetable residuals and the like, are gathered into the voids 24 that open into the external envelope 14 of the cube 12 for being disposed away from the mouth cavity.

Thus, by means of a single action, various advantages are met; brushing the teeth, gums and tongue, disposal of food residuals from the mouth cavity, and applying pleasant odor coming out from the mouth.

Since the cleaning action of the mouth by means of the cube 12 involves no additional action by the hands, the hands remain free and the brushings cleaning action may extend as long as it is required. Thus, the brushing action may take place while standing in a rest room, may take place while sitting in a meeting, in front of a computer, during a cinema show, during driving and the like.

When the user has ceased use of the cube 12, whether it is after a few seconds or a few minutes, it takes the cube 12 out of his mouth and disposes it properly, into an ashtray, garbage can, or the like. In some cases, the cube 12 is made of a water soluble and bio degradable material, in which case it may be freely disposed also in nature without any risk of environmental contamination.

In some cases, the cube is made of on-land grown algae, especially for this purpose. The use of the algae presents several advantages. First, the use of seaweed is avoided since it may be polluted with PCB and other pollutants and heavy metals found in the seas. Second, the depletion of seaweed in the oceans is avoided, thus helping to preserve nature and avoiding destruction of food source for a large number of sea creatures. Third, growing the algae contributes oxygen to the planet. Fourth, the algae, being a natural plant, are bio degradable and therefore may be freely disposed off in nature without causing any contamination. Fifth, the algae may be eaten by the user after being used for cleaning the mouth and teeth. Sixth, the algae may contain omega 3 fatty acid which is essential for proper functioning of human brain and body.

The need to wash the mouth after use of the cube 12 depends on various factors, the majors being the amount of dentifrice applied and its kind. Thus, if it is required, the user may wash his mouth by means of water after the cleaning action. In that case, a near source of water should be available to the user, being a nearby rest room, drinking faucet, or a small bottle of water carried by him.

According to another embodiment of the present invention, the oral device may be used also when a source of water is not available to the user, or if the user wants to keep in private the fact that he has used an oral device to clean its teeth and mouth.

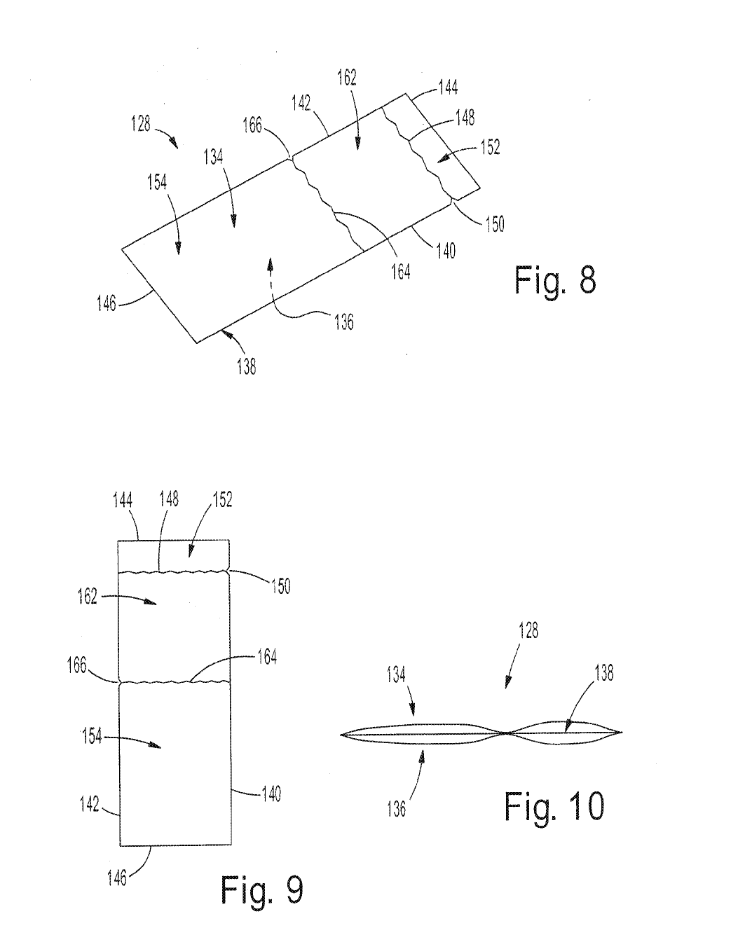

For this reason, reference is now being made to FIGS. 8 to 10 which show another embodiment of the present invention. For the ease of identification of the various components, like parts will be numbered with like reference numerals with added 100.

As shown, an all-inclusive package 128 includes an upper surface 134, a lower surface 136, and a sealing line 138 therebetween. The sealing line 138 is formed from a right sealing line 140 and a left sealing line 142 bounded between a front sealing line 144 and a rear sealing line 146.

The all-inclusive package 128 includes, adjacent the front sealing line 144, a first tearing line 148, extending between the right sealing line 140 and the left sealing line 142. The first tearing line 148 is provided, typically at one end thereof, with a first notch 150 for easing the beginning of the tearing action when required. The all-inclusive package 128 includes three package portions, namely, a front package portion 152, forward to the first tearing line 148, a central package portion 162, rearward to the first tearing line 148, and a rear package portion 154 rearward to the central package portion 162. The rear package portion 154 is separated from the central package portion 162 by a second tearing line 164. The second tearing line 164 is provided, typically at one end thereof, with a second notch 166.

According to some embodiments, the first notch 150 and the second notch 166 are located at opposite sides of the upper surface 134. For example, if the first notch 150 is located at the right sealing line 140, as seen in FIGS. 8 and 9, then, the second notch 166 is located at the left sealing line 142. This construction is beneficial when using the all-inclusive package 128 since it easily enables to differentiate between the first tearing line 148 and the second tearing line 164 before tearing off each one of them.

The central package portion 162 of the all-inclusive package 128 contains therein a cube 12 as described above with respect to the rear package portion 54 of the package 28. The rear package portion 154 of the all-inclusive package 128 contains therein flushing liquid which is, typically, water.

Thus, upon finishing using the cube 12 for the cleaning process of the mouth cavity, and upon taking the cube 12 out of the mouth and disposing it in an appropriate manner, the second tearing line 164 is torn away in a similar manner as explained above with respect to the tearing line 48, and the flushing liquid may be poured into the mouth. Now, the flushing liquid is flushed within the mouth cavity for a few seconds and then it is spitted away.

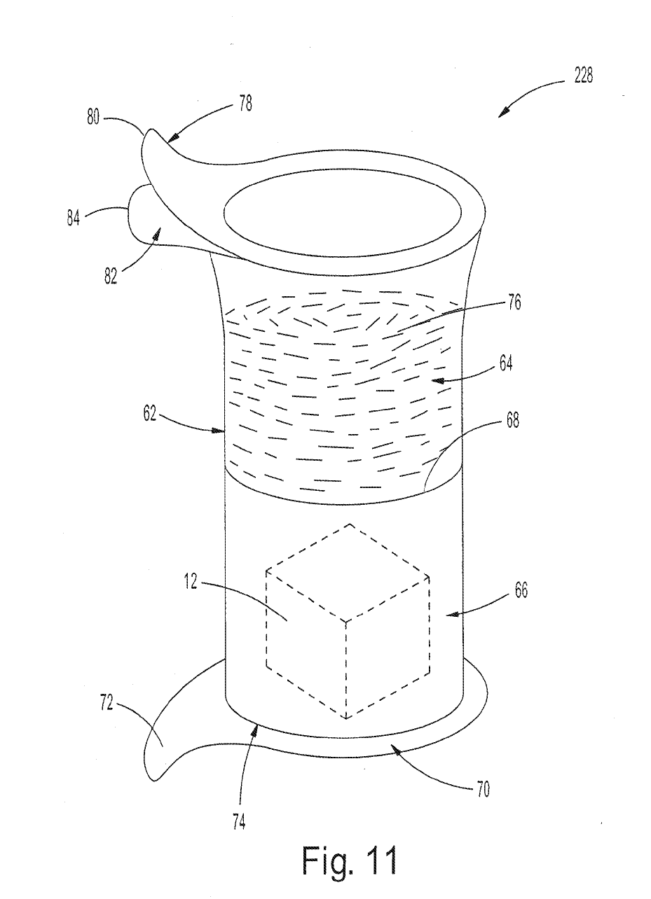

According to another embodiment of the present invention, shown in FIG. 11, a relatively rigid all-inclusive package 228 is used. The rigid all-inclusive package 228 includes a container 62 having an upper compartment 64 that is separated from a lower compartment 66 by means of a partition 68.

The lower compartment 66 contains therein the cube 12 (shown in dashed lines in FIG. 11) and is sealed by means of a lower cover 70 having a lower gripping tongue 72. The lower cover 70 is sealed against a lower lip 74 of lower compartment 66. The lower lip 74 conforms in size and shape with the lower cover 70 except for the lower gripping tongue 72 that remains free.

The upper compartment 64 contains therein flushing liquid 76 (shown in dotted marking in FIG. 11) and is sealed by means of an upper cover 78 having an upper gripping tongue 80. The upper cover 78 is sealed against an upper lip 82 of the upper compartment 64 that conforms in size and shape with the upper cover 78. The upper lip 82 includes a lip tongue 84 that conforms in size and shape with the upper gripping tongue 80.

Typically, in order to ease the gripping of the upper gripping tongue 80, the upper gripping tongue 80 is not sealed against the lip tongue 84 so that the upper gripping tongue 80 can be easily gripped by two fingers in order to tear off the upper cover 78 from the upper lip 82.

When using the rigid all-inclusive package 228, first the lower gripping tongue 72 of the lower cover 70 is held by the user. Then, the lower cover 70 is torn away thus exposing the cube 12. Now, the cube 12 is taken by the user and used as explained above.

After the cube 12 is disposed away, the user opens the upper compartment 64 by holding the upper gripping tongue 80 and tearing off the upper cover 78. The lip tongue 84 of the upper lip 82 functions as an extra safety device for preventing unintentional opening of the upper cover 78.

At the next step, the user pours into his mouth the flushing liquid 76 found in the upper compartment 64 and flushes his mouth for several seconds. Finally, he disposes away the rigid all-inclusive package after being used its contents.

As shown and explained above, the present invention provides an economical and efficient way to preserve the health of the teeth and gums, clean the mouth cavity from food residuals, and give nice breathing odor to the mouth.

The use of the oral device according to the present invention is extremely useful for people who cannot use a chewing gum after a meal, as is widely use these days, in a case they have problematic dental caps or problematic dental fillings which may be damaged or pulled away by a chewing gum.

Although the present invention has been described to a certain degree of particularity, it should be understood that various alterations and modifications could be made without departing from the spirit or scope of the invention as hereinafter claimed.

For example, the release of the cube 12 from within the package 28 does not have to be carried out by tearing apart the front package portion 52 with respect to the rear package portion 54, and other opening methods may be equally applied. For example, the upper surface 34 of the package may be attached to the lower surface 36 of the package by sticky glue. Thereby, in order to be separated, the upper surface of the package and the lower surface of the package are pulled away in contrary directions.

The second tearing line does not have to extend from the right sealing line to the left sealing line. Thus, when the second tearing line is shorter, the opening of the rear package compartment containing the flushing liquid is shorter and it may be easier to sip the flushing liquid from the rear package compartment of the all-inclusive package.

The construction of the upper cover and lower cover of the rigid all-inclusive package does not have to be as described above and other construction techniques may be equally applied. For example, the lower lip may be provided with a lip tongue, like the lip tongue of the upper lip. The upper lip may be constructed without a lip tongue, like the construction of the lower lip.

The package of the oral device is not limited to the number of portions described above and further package portions may be provided if required. These extra package portions may contain a candy, a chewing gum, or the like.

The oral device does not have to be homogeneous and other structures may be applied. For example, the vertexes of a cube may be produced from a relatively harder material, being a sponge or the like, and the rest of the cube may be produced from a relatively softer material. In that manner, the efficiency of the cube, or any other given shape of the oral device, may be increased. First, the relatively hard vertexes, and also the edges if desired, may do better a rubbing and pulling action when they enter into hard-to-reach spaces between the teeth. This action can be similar to the action of toothbrush bristles. Second, the relatively soft internal core may ease the application by the tongue, may hold more quantity of dentifrice, and may gather more food residuals into the voids.

In some specific embodiments, the oral device does not consist of a single constituent and it may be formed from two, or more, different materials. Thus, by having the oral device formed from different materials, different properties may be applied to different parts of the oral device, according to specific needs.

The oral device does not have to be formed as a cube and other forms may be implemented. According to some embodiments, the oral device may be produced in a large variety of geometrical shapes, such as pyramid, box, ball, sea star, volumetric extended triangle, and the like. According to other embodiments, the oral device may be formed in an appealing form for children. Thus, the oral device may be formed in a large variety of animal shapes, a fact that may ease the convincing of the children to use the oral device in order to protect their mouth cavity.

The oral device may be produced in different colors for identifying different sizes, shapes, functions, construction, etc. Furthermore, each oral device may consist of various colors which may emphasize vertexes, edges and the like.

The package, the all-inclusive package and the rigid all-inclusive package may be formed from a transparent material or from an un-transparent material.

The dentifrice may have different tastes like mint, strawberry, apple, pear and the like. Furthermore, the dentifrice may be provided with a variety of odors like strawberry, mint and the like. The odor may be provided with a variety of strengths, like mild, medium and strong.

What is claimed is:

1. A single use flexible disposable oral device, which is operated either by the tongue or by a chewing action, for cleaning the entire mouth cavity.

2. The device according to claim 1, wherein: the oral device comprises an external envelope and an internal core, the external envelope comprises faces having edges and vertexes, and the oral device being non-homogenous, and the vertexes are harder than the faces and the internal core.

3. The device according to claim 2, wherein the edges are harder than the faces and the internal core.

4. The device according to claim 1, wherein the oral device contains a dentifrice.

5. The device according to claim 1, wherein the oral device is made of a spongy material.

6. The device according to claim 1, wherein the oral device is made of algae.

7. The device according to claim 1, wherein the oral device is water soluble.

8. The device according to claim 1, wherein the oral device is bio degradable.

9. The device according to claim 1, wherein the oral device is in a form of a cube.

10. The device according to claim 1, wherein an external envelope of the oral device is provided with voids.

11. The device according to claim 1, wherein the oral device is contained within a package.

12. The device according to claim 11, wherein the package is flat.

13. The device according to claim 1, wherein the oral device is contained within an all-inclusive package.

14. The device of claim 13, wherein the all-inclusive package is provided with at least two package portions, a first package portion contains therein the oral device, and a second package portion contains therein flushing liquid.

15. The device according to claim 13, wherein the all-inclusive package comprises at least two rigid compartments, at least a first compartment comprises therein the oral device, and at least a second compartment comprises therein flushing liquid.

16. The device according to claim 1, wherein the oral device forms a convex body.

17. The device according to claim 1, wherein in an un-squeezed form of the oral device, a maximal external dimension (L) of the oral device is in the range of 5 mm to 50 mm.

18. The device according to claim 15, wherein: in an un-squeezed form of the oral device, the maximal external dimension (L) of the oral device is in the range of 10 mm to 30 mm.
